(19) United States
(12) Patent Application Publication
(10) Pub. No.: US 2019/0340602 A1
(43) Pub. Date: Nov. 7, 2019

(54) PORTABLE DEVICE FOR MANAGING REWARD POINTS AND METHOD THEREOF

(71) Applicant: NANNING FUGUI PRECISION INDUSTRIAL CO., LTD., Nanning (CN)

(72) Inventor: GUAN-FU LI, Hsin chu (TW)

(21) Appl. No.: 15/969,409

(22) Filed: May 2, 2018

(51) Int. Cl. G06Q 20/32; G06Q 30/02; G06Q 20/38; H04W 4/80

(52) U.S. Cl. CPC G06Q 20/3278; G06Q 30/0233; G06Q 20/202; G06Q 20/387; H04W 4/80; G06Q 20/3226

(57) ABSTRACT

A method for managing reward points which can be applied in a portable device with a secure element for storing reward points comprises exchanging near field communication data exchange format (NDEF) messages with a computer device when the portable device is placed in close proximity to the computer device. An application running on the portable device performs various reward points operations according to a payload of a received NDEF message and can update the reward points stored in the secure element following such operations.

### FIELD

The subject matter herein generally relates to network communications, in particular to a portable device to manage reward points.

### BACKGROUND

Existing methods to earn reward points allow the earning of physical reward point stickers or different APPs issued by vendors. For physical reward point stickers, customers receive different reward cards of different vendors. If customers forget to paste the card or sticker in place, it can be easily lost. As reward points are earned through the Apps, in addition to being familiar with different APP interfaces of different vendors, the process of redeeming reward points is sometimes complicated.

### BRIEF DESCRIPTION OF THE DRAWINGS

Implementations of the present technology will now be described, by way of example only, with reference to the attached figures, wherein:

FIG. 1 is a block diagram of one embodiment of a communication system including a portable device and a point of sale terminal.

FIG. 2 is a structure of one embodiment of an NDEF message.

FIG. 3 is a flow chart of one embodiment of a process for awarding reward points to a user.

FIG. 4A is one embodiment of a notification screen that may be displayed to a user.

FIG. 4B is one embodiment of a user interface to display to a user the details of reward points.

FIG. 5 is one embodiment of a user interface for redeeming rewarding points.

FIG. 6 is a flow chart of one embodiment of a process for vendor-redemption of reward points.

FIG. 7 is a flow chart of one embodiment of a process for transferring rewarding points between users.

FIG. 8 is a flow chart of one embodiment of a process for recovery of rewarding points with a vendor.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

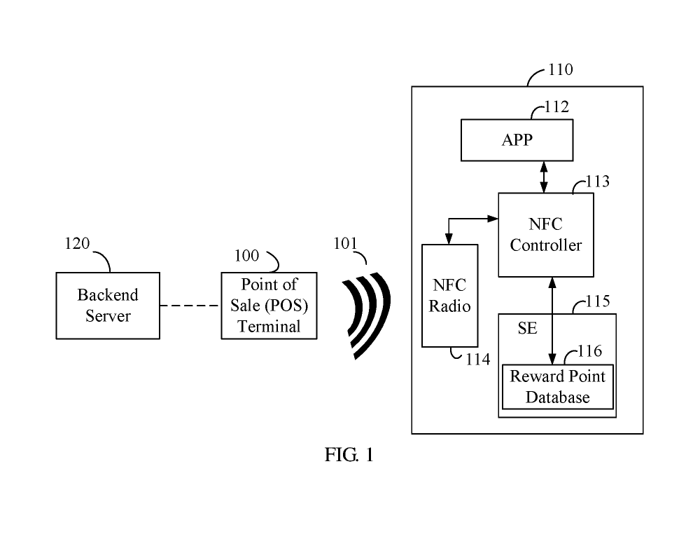

FIG. 1 illustrates a communication system in accordance with one embodiment. The communication system comprises a point-of-sale terminal (POS 100), a portable device 110, and a backend server 120. In one embodiment, the POS 100 gives rewards points to the user according to the consumption amount, the portable device 110 manages the amount of reward points of the user, and the backend server 120 verifies the rewards and redemption of reward points. The POS 100 is connected to the backend server 120 using a communication channel such as the Internet. The portable device 110 and the backend server 120 may communicate to each other using WIFI or any other mobile communication protocol.

The backend server 120 may comprise a database that stores accounts of various users. The accounts may store information regarding the loyalty awards (loyalty account) of each user. The account may comprise reward policies and rules for the account, reward points accumulated by the user, expiration date of reward points, and other information regarding the user's account. Thus, the vendor may keep track of each user's rewardable activities by these accounts. The vendor may also facilitate redemption of reward points to the user through these accounts. In one embodiment, the backend server 120 maintains the account on a user- and vendor-specific basis. User may interact with various vendors and earn individualized reward points that are specific to the user's transactions with each vendor.

The POS 100 may be a computer device such as a POS cash register, an interactive kiosk, and so forth. The portable device 110 may be a computer device such as a smart phone, a mobile phone, a tablet computer device, a notebook computer, and so forth which the user brings with him/her. The portable device 110 may interact with the POS 100 through short range wireless communication protocol 101, such as Near Field Communication (NFC). In one embodiment, the portable device 110 is an NFC-enabled device. The portable device 110 comprises an NFC controller 113 and an NFC radio 114 coupled with the NFC controller 113. The NFC controller 113 and the NFC radio 114 cooperate to perform NFC communication with the POS 100 to provide data to or receive information from the POS 100.

In one embodiment, the portable device 110 comprises one or more mobile applications (APPs) 112, and a secure element (SE) 115. The App 112 is a program, function, routine, applet, and so forth. The APP 112 implements the managing of reward points of the user and transmits/receives reward point information to/from the POS 100. Additionally, the SE 115 also may comprise contactless software applications, such as secure forms of the APP 112, authentication applications, or other application using the secure functionality of the SE 115. The SE 115 is a secure area of memory that is used for securely storing NFC applications and sensitive data for use by the NFC controller 113. In one embodiment, the SE 115 is used to securely store and provide access to customer data and a reward point database 116. The customer data comprises the user ID, username, user's password which may be encrypted, and so forth. The reward point database 116 stores a history of the reward point information. The reward point information comprises columns of vendor IDs, date/time, transaction data, reward points, and expiration dates. The column of the vendor ID is an identification of the vendor which issues the reward points. The column of date/time is the timestamp of a transaction. The column of transaction data may comprise information regarding the transaction such as consumption amount and so forth. The column of the reward points is the amount of reward points to be awarded to the user based on the consumption amount included in the transaction data. The column of the expiration data is the expiration dates of the reward points.

In one embodiment, the user brings the portable device 110 to close proximity of the POS 100 to earn reward points by waving the portable 110 over the POS 100 at the vendor location. The APP 112 running on the portable device 110 comprises a user interface (UI) for interacting with different loyalty programs provided by different vendors. In one embodiment, the user selects loyalty cards for a transaction (either with or without password/mobile PIN authentication in the SE 115), checks reward points accumulated in a loyalty program, and indicates an amount of reward points to be redeemed against a transaction. To transfer data between the portable device 110 and the POS 100, the data is represented based on a well-defined NFC format called NFC Data Exchange Format (NDEF).

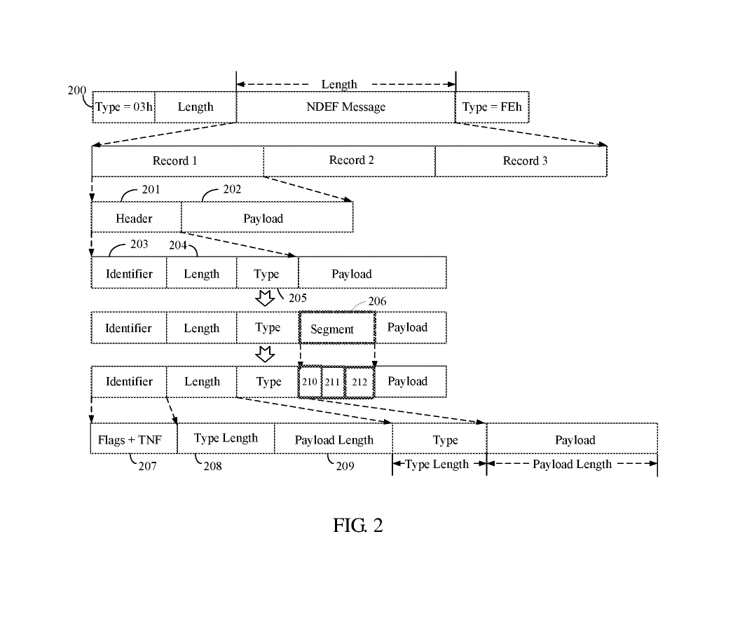

FIG. 2 illustrates format of an NDEF message Tag Length Value (TLV) data 200. The NDEF message TLV data 200 may comprise the NDEF message. The NDEF message TLV data 200 may comprise flags that indicate the start and stop of data. For example, type field value 0x03 provides the starting point, value of length field is equal to the size in bytes of the NDEF message, value field stores the NDEF message, and a terminator TLV with type field value equal to 0xEF indicates the last TLV block of data. The NDEF message may comprise a plurality of records. FIG. 2 shows three records, i.e. record 1, record 2, and record 3. The NDEF message is a binary message format designed to encapsulate application-defined payloads into a single message construct. Each NDEF message may comprise a sequence of records with each record consisting of at least two parts, a header 201 and payload data 202. The header 201 may comprise data representing a wide variety of address, control, and similar information, such as for example, an identifier field 203, a length field 204, and a type field 205. The identifier field 203 is an optional field, which may allow applications to identify payload carried within any specific NDEF record. In one embodiment, the identifier field 203 may comprise five-bit flags and a three-bit Type Name Form (TNF) field 207. Each bit of the flags can indicate the specific information associated with the context data, and the TNF field value indicates the format of the type field 205 value. Value in the length field 204 indicates length of the payload that is encapsulated in a record. In one embodiment, the length field 204 may further comprise the type length field 208 and the payload length field 209. Value in the type length field 208 indicates length of the type field 205, and value in the payload length field 209 indicates length of the payload data 202. The length of the payload data 202 may be one byte for short records and may be four bytes for normal records. Value in the type field 205 indicates type of data being carried in the payload data 202. The type information may be used by the receiving application to decide processing mechanism to be adopted.

The content of the payload data 202 is application-specific and related to the value of the type field 205. The payload data 202 may comprise two parts, a segment field 206 followed by additional payload data. The segment field 206 is used for communicating reward points information. In one embodiment, the segment field 206 may comprise an L subfield 210, a T subfield 211, and a V subfield 212. The L subfield 210 indicates length of the segment field 206 measured in bytes. The T subfield 211 is a two-bit subfield indicating operation type of NFC signal. For example, the T subfield 211 can comprise a binary value “00” when the NDEF message is used for awarding reward points, a binary value “01” when the NDEF message is used for transferring reward points, a binary value “10” when the NDEF message is used for recovering reward points, and a binary value “11” when the NDEF message is used for redeeming reward points. The V subfield 212 is a six-bit subfield indicating content of NFC signal. For example, the MSB two bits indicate the vendor ID, the middle two bits indicate consumption list, and the LSB two bits indicate the number of reward points. Other embodiments may include additional or alternative subfields as may be defined by other implementations.

In order to earn reward points, the user can simply select products, and then bring the portable device 110 close to the POS 100 to make a transaction. The POS 100 may further identify each of the products that the user intends to purchase. For example, a vendor may use scanner to scan barcodes or other identifiers from each of the products. The POS 100 may receive product identifier for each of the products and thus identify the products that the user intends to purchase. The POS 100 may then determine a total purchase price for the identified products and present the total purchase price to the user for payment. For example, the POS 100 may display the total purchase price on a display device of the POS 100 in order to inform a vendor employee and/or the user of the determined purchased price. The vendor may determine that sufficient payment has been received for the identified products. Before or after finalizing payment, the POS 100 may present the user with details regarding reward points earned as a result of the transaction on the display device. The reward points may be functionally related to the determined purchased price.

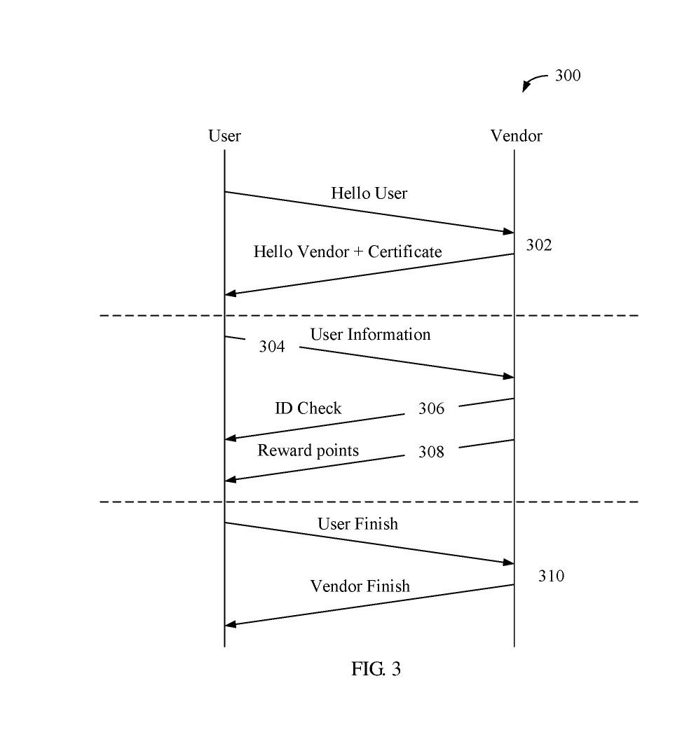

FIG. 3 illustrates a flow chart for a process 300 that may be implemented to award reward points to the user. In one embodiment, the POS 100 may be operating in the “host mode” and may emit periodic NFC signals. In order to earn reward points, the portable device 110 is brought into close proximity with the POS 100 by the user and detects one of the NFC signals emitted by the POS 100. In response to detecting the NFC signal, the NFC controller 113 of the portable device 110 may launch or activate the APP 112. In step 302, handshake may next take place between the portable device 110 and the POS 100 to establish an NFC connection. In one embodiment, the portable device 110 may transmit a hello message to the POS 100. The hello message can be any combination of greeting, capabilities, characteristics, certificate or handshake signal that can be used to facilitate the NFC connection session. Following establishment of the NFC connection session, the portable device 110 and the POS device 100 may communicate further. Thus, in step 304, the portable device 110 sends a reward request to the POS 100 through the established NFC connection, the reward request including the account information of the user. The account information may comprise a unique device ID (UDID) and/or a phone number of the portable device 110. The POS 100 may send the UDID and/or the phone number to the backend server 120 for identifying the user, which may create an initial account of the user. The POS 100 may also inform the backend server 120 of the transaction information of the user. The transaction information causes the backend server 120 to credit a predetermined quantity of reward points to the user's account. Likewise, the backend server 120 may also generate additional personalization information per vendor for the account using the transaction information obtained from the POS 100. Once the user is identified and a record about transaction information together with a current value of reward points associated with the user and the vendor is stored by the backend server 120, in step 306, the POS 100 sends a confirmation message in response to the reward request received and the user is identified. In next step 308, the POS 100 communicates the earned reward points to the user. Data exchanged between the portable device 110 and the POS 100 are represented based on NDEF messages, which are by the T subfield 211 with a binary value of “00”. Finally, the reward point information can be stored in the reward point database 116 by the APP 112 and the user is notified that the reward points associated with the vendor have been updated by the APP 112. For example, the APP 112 can generate and push an APP notification through a user interface, and the vendor information and current value of reward points are then displayed on a display of the portable device 110. In one embodiment, the user interface can be provided to the user to categorize and/or to organize vendors and associated vendor loyalty programs. After awarding reward points to the user, the NFC connection can then be terminated in step 310.

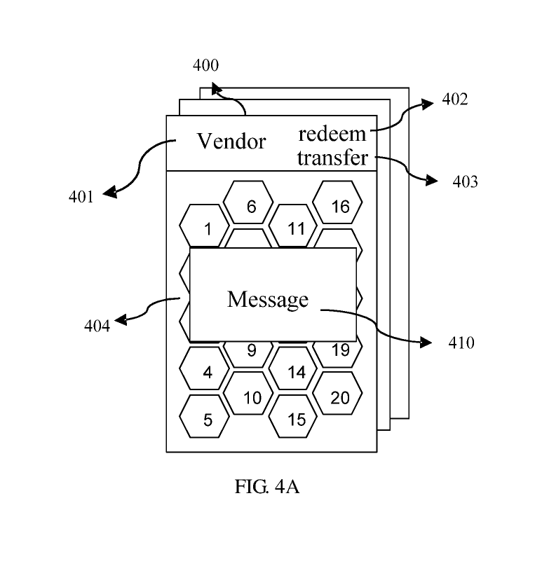

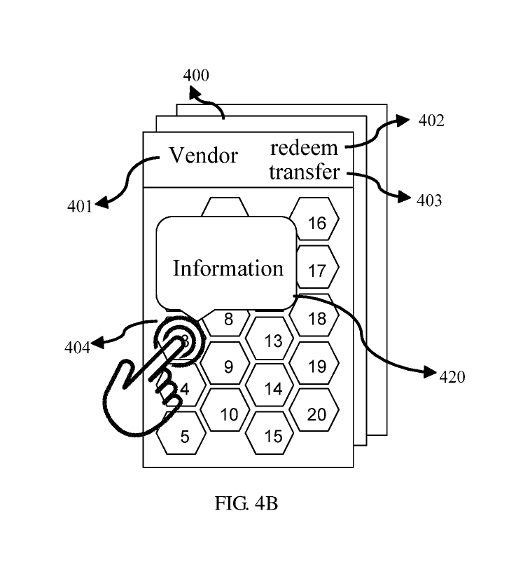

In one embodiment, the APP 112 may monitor expiry of accumulated reward points associated with a specific vendor. A notification to the user using the portable device 110 can be generated to inform the user about reward points with predefined expiration dates, and to further inform the user how many days and/or time remain to redeem certain reward points. FIG. 4A shows an example of one such notification screen 410 that may be displayed to the user. As shown, the user interface 400 may also provide various types of information 401 about the vendor, including the vendor name, address, and business hours. Additionally, the user interface 400 may show current reward points that the user has earned 404 from the vendor. The user interface 400 may provide a “redemption” button 402 for redeeming reward points and a “transfer” button 403 for transferring reward points to another user. The user interface 400 may comprise different pages per vendor for displaying various loyalty programs that the user has participated. In one embodiment, the user interface 400 may be displayed on a touch-sensitive display. In this embodiment, the user can select one of the reward points by making a 3D touch gesture with one finger. Based on the gesture determined, the portable device 110 displays a pop-up screen 420, as shown in FIG. 4B, adjacent to and pointed at by the tip of finger to show details about the reward points.

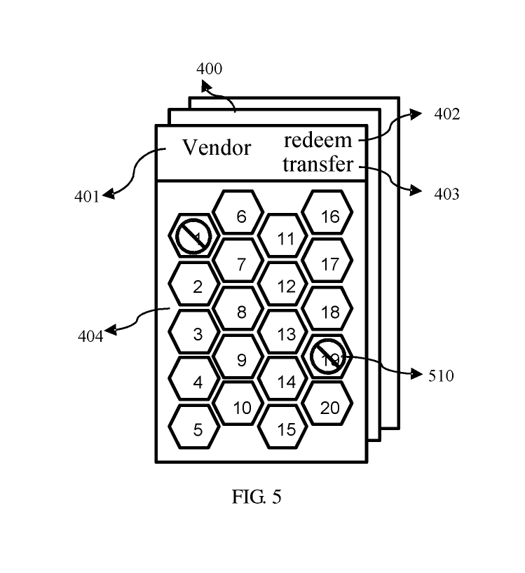

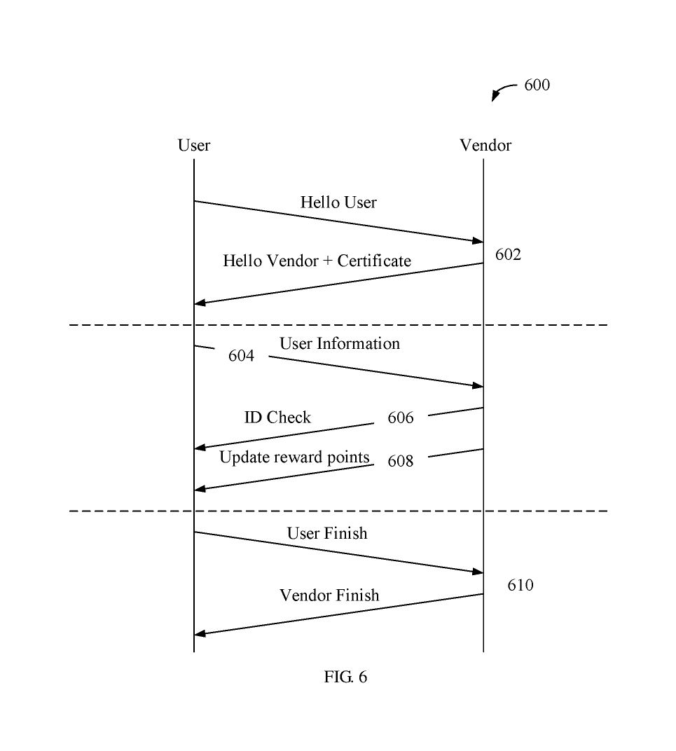

In one embodiment, the APP 112 may comprise functionality, operations and/or user interfaces to redeem reward points offered by the vendor. If the user wishes to redeem reward points, the user opens the APP 112, positions the portable device 110 within a predetermined distance of the POS 100, and subsequently uses the user interface 400 of the APP 112 to select reward points for redemption, the pressing the “redemption” button 402. If reward points have been redeemed, the user interface 400 shows the redeemed reward points now unavailable 510 (see FIG. 5). FIG. 6 illustrates a flow chart for a process 600 that may be implement for redeeming reward points with the vendor. Firstly, in step 602, a handshake is performed between the portable device 110 and the POS 100 to establish an NFC connection. Then in step 604, the portable device 110 sends a redemption request to the POS 100 through the established NFC connection, the redemption request including an amount of reward points that are being redeemed and the account information of the user. In one embodiment, the POS 100 forwards the amount of reward points and the account information to the backend server 120. If the backend server 120 determines that the account information matches and the amount of reward points which can be redeemed, the redemption request is approved. The backend server 120 provides an authorization response to the POS 100, which causes the POS to accept the redeemed amount, and updates the reward points balance associated with the account. The POS 100 then generates an authorization response (step 606) to the portable device, and communicates the remaining amount of reward points in the account with the portable device (step 608). Data exchanged between the portable device 110 and the POS 100 are represented based on NDEF messages, which are by the T subfield 211 with a binary value of “11”. Finally, the reward point information stored in the reward point database 116 is updated with the amount of the redeemed reward points by the APP 112. After completion of redeeming reward points, the NFC connection can then be terminated in step 610.

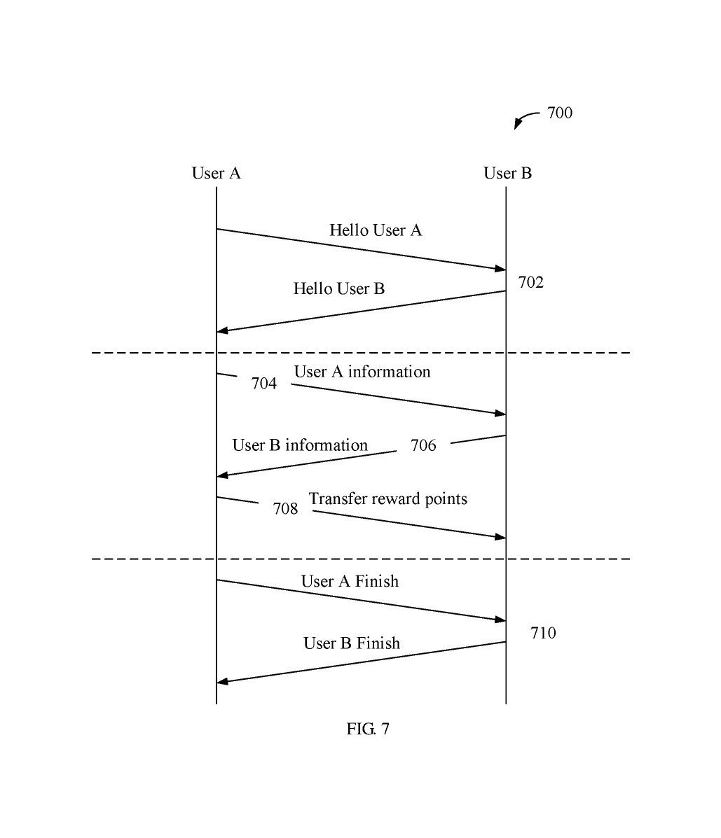

In one embodiment, the user may be able to gift an amount of reward points to another user, e.g. a friend or family member. In another embodiment, the user may transfer reward points earned in exchange for reward points of other loyalty programs. FIG. 7 illustrates a flow chart for a process 700 that may be implemented for transferring reward points between a user A and a user B. The user A's portable device 110 and the user B's portable device 110 may communicate between each other through an NFC connection. Prior to establishing the NFC connection, the user B's portable device 110 may be in a “Wake on NFC” mode. In this mode, the APP 112 may remain inactive until an NFC signal is received from another portable device 110. In order to transfer an amount of reward points from the user A to the user B, the user A's portable device 110 is brought into close proximity to the user B's portable device 110, then the user A opens the APP 112. The user interface 400 can be used to select certain reward points and the “transfer” button 403 pressed to initiate the transfer of reward points. The user A's portable device 110 then emits NFC signals to seek out other nearby NFC-enabled device. When the user B's portable device 110 detects the NFC signal radiated by the user A's portable device 110, the NFC controller 113 of the user B's portable device 110 may launch or activate the APP 112, and then the establishment of the NFC connection in step 702 may begin with an initiation handshake. The user A's portable device 110 and the user B's portable device 110 may exchange device profiles, as in step 702. The device profiles may include a variety of information regarding the capabilities of the user A's portable device 110 and the user B's portable device 110. Following establishment of the NFC connection in step 702, the user A's portable device 110 and the user B's portable device 110 may remain in communication. Thus, in step 704, the user A's portable device 110 sends a transfer request to the user B's portable device 110. The transfer request represents a request from the user A's portable device 110 to the user B's portable device 110 to transfer at least one reward point between the user A's account and the user B's account of one specific vendor. The transfer request may also indicate the amount of reward points transferred. Then the user A's portable device 110 may receive an approval from the user B's portable device 110 as in step 706. In one embodiment, the user A's portable device 110 and the user B's portable device 110 may also exchange information related to their respective accounts as in steps 704 and 706. Upon receiving transfer request approval, the APP 112 of the user A's portable device 110 updates reward points balance of the related account in the reward point database 116 of the user A's portable device 110. In step 708, the user A's portable device 110 notifies the user B's portable device 110 to complete the transferring of an amount of reward points. Then the APP 112 of the user B's portable device 110 updates reward points balance of the related account in the reward point database 116 of the user B's portable device 110. Data exchanged between the user A's portable device 110 and the user B's portable device 110 are represented based on NDEF messages, which are by the T subfield 211 with a binary value of “01”. Upon successfully completing the transfer request, the user A's portable device 110 may inform the backend server 120 about the amount of reward points transferred, the updated balance amount, and the user B's information. Accordingly, the backend server 120 may subtract the amount of reward points from the user A's account and deliver the amount of reward points to the user B's account. The NFC connection can then be terminated as in step 710.

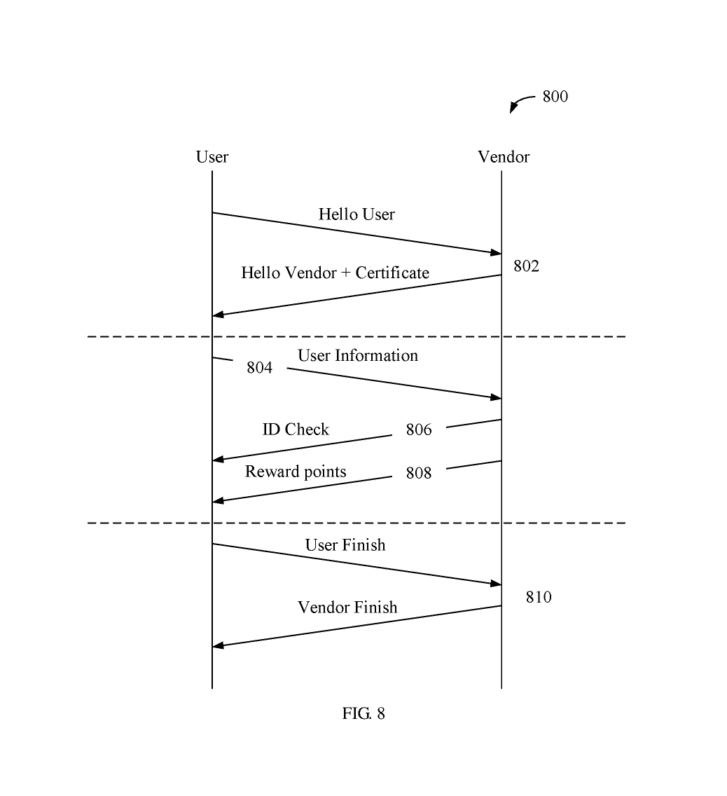

In one embodiment, the user may be able to recover the reward point database 116 after performing a factory reset on the portable device 110. In one example loyalty program, the reward points may be earned in a designated time period. The user is eligible to recover the reward points earned during the designated time period. If the user wants to recover the reward points earned, the user may bring the portable device 110 to a vendor location within the designated time period, and then talk to the vendor about recovering the reward points. The vendor may utilize the POS 100 to interact with the portable device 110 at the vendor location to deliver reward point information. FIG. 8 illustrates a flow chart for a process 800 that may be implemented to recover reward points for the user. In one embodiment, the POS 100 may be operating in the “host mode” and may emit periodic NFC signals. In order to recover lost reward points earned, the portable device 110 is brought into proximity of the POS 100 by the user and detects one of the NFC signals emitted by the POS 100. In response to detecting the NFC signal, the NFC controller 113 of the portable device 110 may launch or activate the APP 112. In step 802, handshake may next take place between the portable device 110 and the POS 100 to establish an NFC connection. Following establishment of the NFC connection session, the portable device 110 and the POS device 100 may communicate further. Thus, in step 804, the portable device 110 sends a recovery request to the POS 100 through the established NFC connection, the recovery request including the account information of the user. The account information may comprise a unique device ID (UDID) and/or a phone number of the portable device 110. The POS 100 may communicate with the backend server 120 in order to verify the identity of the user. The backend server 120 may determine whether the user is enrolled for a loyalty program of the vendor. If the user is identified by the backend server 120, and in the event that the user has enrolled in a loyalty program, the backend server 120 can transmit reward point information associated with the account of the user to the POS 100. Then the POS 110 sends an approval in response to the recovery request of the portable device 100 in step 806 and subsequently sends reward point information associated with the account of the user to the portable device 110 as in step 808. The portable device 110 can then store the reward information in reward point database 116. Data exchanged between the portable device 110 and the POS 100 are represented based on NDEF messages, by the T subfield 211 with a binary value of “10”. Finally, the reward point information stored in the reward point database 116 is updated with the amount of the redeemed reward points by the APP 112. After completion of recovery of reward points with the vendor, the NFC connection can then be terminated as in step 810.

Thus, the portable device 110 provides user-friendly management of reward points across multiple separate vendors for the user. Further, by virtue of the short-range communication features described herein, various embodiments encourage potential customers to patronize local vendors.

The embodiments shown and described above are only examples. Many details are often found in the art such as the other features of a portable device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A portable device for reward points management, the portable device comprising:
a near field communication (NFC) radio configured to receive at least one NFC signal from a computer device when the portable device is placed into close proximity to the computer device;
a secure element (SE) capable of storing reward points; and
an application is launched in response to the NFC radio receiving the at least one NFC signal, wherein the application is configured to:
receive a NFC data exchange format (NDEF) message from the computer device, wherein the NDEF message comprises a payload;
perform reward points operation according to the payload; and
update the reward points stored in the SE.

2. The portable device of claim 1, wherein the payload comprises an operation type field comprising a predefined value that indicates operation is to be performed.

3. The portable device of claim 2, where in the computer device comprises a point-of-sale terminal and another portable device.

4. A portable device for reward points management, the portable device comprising:
a near field communication (NFC) radio configured to communicate with a computer device when the portable device is placed into close proximity to the computer device;
a secure element (SE) capable of storing reward points; and
an application is running on the portable device, wherein the application is configured to:
receive a user input from a user interface provided by the application;
send a first NFC data exchange format (NDEF) message to the computer device according to the user input, wherein the first NDEF message comprises a first payload.
receive a second NDEF message from the computer device, wherein the second NDEF message comprises a second payload;
perform reward points operation according to the second payload; and update the reward points stored in the SE.

5. The portable device of claim 4, wherein both the first payload and the second payload comprise operation type fields comprising a predefined value that indicates operation is to be performed.

6. The portable device of claim 5, where in the computer device comprises a point-of-sale terminal.

7. A method of reward points management, the method comprising:
providing, by a portable device, an user interface to interact with a user;
exchanging a near field communication data exchange format (NDEF) message, by the portable device and with a computer device through a near field communication, when the portable device is placed into close proximity to the computer device;
performing reward points operation according to a payload of the NDEF message.

8. The method of claim 7, wherein the computer device comprises a point-of-sale terminal and another portable device.

9. The method claim 7, wherein the payload comprises an operation type field comprising a predefined value that indicates operation is to be performed.

10. The method of claim 7, further comprising:
updating the reward points stored in a secure element of the portable device.
